(19) United States
(12) Patent Application Publication
(10) Pub. No.: US 2016/0369989 A1
(43) Pub. Date: Dec. 22, 2016

(54) Shoe with Alert and Health Arrangement

(71) Applicant: Jason Dan CHU, Diamond Bar, CA (US)

(72) Inventor: Jason Dan CHU, Diamond Bar, CA (US)

(21) Appl. No.: 14/743,998

(22) Filed: Jun. 18, 2015

(51) Int. Cl. F21V 23/04; F21S 9/02; F21V 8/00; F21V 33/00; G08B 5/36; A43B 3/00

(52) U.S. Cl. CPC F21V 23/0435; G08B 5/36; A43B 3/001; G02B 6/001; G02B 6/0096; F21V 33/0008; F21V 23/0485; F21S 9/02; F21Y 2101/02; F21W 2111/10

(57) ABSTRACT

A shoe includes a shoe body, an alert module, and a control module. The alert module includes a light source supported at the shoe body for generating light with different light effects as a visible alert signal. The control module includes a health monitoring module serving as a pedometer to automatically switch the light source from one light effect to another light effect in response to the number of steps of the wearer.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a footwear, and more particular to a shoe with alert and health arrangement, wherein when the shoe is worn, the shoe generates not only an alert signal in a dark environment but also a health signal to monitor the health condition of the wearer.

### Description of Related Arts

A conventional lighted shoe in accordance with the prior art generally comprises a shoe insole made of transparent material, a shoe cover body affixed to the shoe insole, and a light arrangement. The light arrangement comprises a plurality of LEDs spacedly affixed at an inner peripheral portion of the shoe insole and a light switch connected to the LEDs to selectively activate the LEDs. During walking or running, the light switch is actuated for activating the LEDs to generate visual light effect which makes the wearer safe in a dark environment. However, such lighted shoe has several drawbacks.

As each LED represents a single point source of light, the light arrangement can only generate a plurality of discrete light sources. In other words, the light generated by the LED is highly concentrated that the light sources form a plurality of visible bright spots respectively at the shoe insole. It is unpleasant that the discrete light sources are emitted around the shoe insole. In addition, the discrete light sources cannot provide wide regions of illumination. In addition, the LEDs are electrically connected in a series connection, such that when one of the LEDs is damaged, all the LEDs cannot be operated normally. However, the LEDs are irreplaceable by embedding the LEDs at the shoe insole. It is awful that when only one shoe is lighted while anther shoe is unlighted. In other words, if only one LED is damaged, the pair of shoes will not be worn anymore. It is worth mentioning that the shoe insole must be made of transparent material for allowing the lights from the LEDs transmitting through the shoe insole. In other words, the LEDs can only provided within the shoe insole but not at the shoe cover body. Therefore, the decorative design of the shoe is limited by the transparent shoe insole.

### SUMMARY OF THE PRESENT INVENTION

The invention is advantageous in that it provides a shoe with alert and health arrangement, wherein when the shoe is worn, the shoe generates not only an alert signal in a dark environment but also a health signal to monitor the health condition of the wearer.

Another advantage of the invention is to a shoe with alert and health arrangement, wherein an alert module comprises a light transmitting element for transmitting the light from the light source to form a continuous line of light at the shoe body as a visible alert signal.

Another advantage of the invention is to a shoe with alert and health arrangement, wherein the light source is invisible hidden within the shoe to prevent any visible bright spot at the shoe body and to ensure an even light intensity of the continuous line of light at the shoe body.

Another advantage of the invention is to a shoe with alert and health arrangement, wherein the light transmitting element is extended along an outer peripheral edge of the shoe insole, such that the shoe insole can be made of non-transparent material or light-blocking material to incorporate with the alert module.

Another advantage of the invention is to a shoe with alert and health arrangement, wherein the control module not only controls the activation of the light source but also serves as a pedometer to generate the health signal via the alert module.

Another advantage of the invention is to a shoe with alert and health arrangement, wherein the wearer is able to selectively control the activation of the light source via a control application being installed into an electronic device, such that the control application is adapted for receiving health data from the control module to analyze the foot activities of the wearer and for sending control data to the control module to control the alert module.

Another advantage of the invention is to a shoe with alert and health arrangement, wherein the control module is adapted to incorporate with any existing lighted shoe with a light module to control the activation thereof and to provide an additional health information to the wearer.

Another advantage of the invention is to a shoe with alert and health arrangement, which does not require to alter the original structural design of the shoe, so as to minimize the manufacturing cost of the shoe incorporating with the alert and health arrangement.

Another advantage of the invention is to a shoe with alert and health arrangement, wherein no expensive or complicated structure is required to employ in the present invention in order to achieve the above mentioned objects. Therefore, the present invention successfully provides an economic and efficient solution for providing a visible alert signal and health signal to the wearer.

Additional advantages and features of the invention will become apparent from the description which follows, and may be realized by means of the instrumentalities and combinations particular point out in the appended claims.

According to the present invention, the foregoing and other objects and advantages are attained by a shoe which comprises a shoe body and an alert module.

The alert module comprises a light source supported at the shoe body for light generation, and a light transmitting element operatively extended from the light source to the shoe body for transmitting the light from the light source to form a continuous line of light at the shoe body as a visible alert signal.

In accordance with another aspect of the invention, the present invention comprises a shoe which comprises a shoe body, an alert module, and a control module.

The alert module comprises a rechargeable power unit, and a light source which is electrically linked to the rechargeable power unit and is supported at the shoe body for generating light with different light effects as a visible alert signal.

The control module comprises an activation switch operatively linked to the alert module to activate the light source, and a health monitoring module operatively linked to the activation switch to automatically switch the light source from one light effect to another light effect when a predetermined number of activation of the activation switch is over a preset step threshold.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a shoe with an alert and health arrangement according to a preferred embodiment of the present invention, illustrating the alert module providing a continuous line of light at said shoe body as a visible alert signal.

FIG. 2 is a sectional view of the shoe with the alert and health arrangement according to the above preferred embodiment of the present invention, illustrating the invisible hidden light source.

FIG. 3 is a partially perspective view of the shoe with the alert and health arrangement according to the above preferred embodiment of the present invention, illustrating the light transmitting element extended along a receiving groove formed at an outer peripheral edge of the shoe insole.

FIG. 4 illustrates an alternative mode of the light transmitting element of the alert module of the shoe according to the above preferred embodiment of the present invention, illustrating the flexible light tube with a solid light transmitting channel.

FIG. 5 is a block diagram of the shoe with the alert and health arrangement according to the above preferred embodiment of the present invention.

FIG. 6 illustrates an alternative mode of the light source of the alert module of the shoe according to the above preferred embodiment of the present invention.

DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

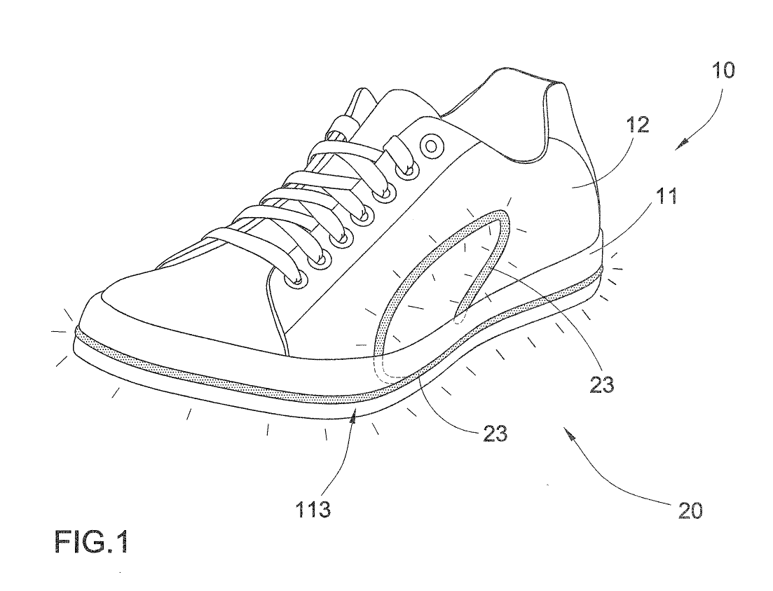

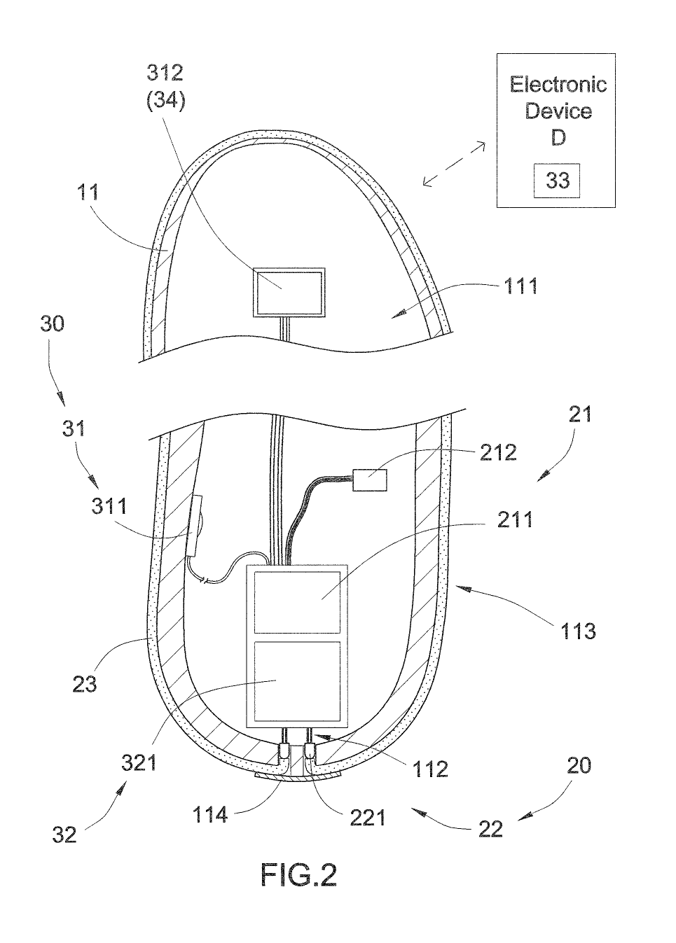

Referring to FIGS. 1 and 2 of the drawings, a shoe according to a preferred embodiment of the present invention, wherein a wearer is able to wear a pair of shoes of the present invention as the sports shoes. The shoe of the present invention comprises a shoe body 10, an alert module 20, and a control module 30.

The shoe body 10 generally comprises a shoe insole 11 and a shoe cover 12 affixed on the shoe insole 11, Preferably, the insole 11 has an insole cavity 111 and a shoe insole layer covering on the shoe insole 11 to enclose the insole cavity 111.

The alert module 20 comprises a rechargeable power unit 21 and a light source 22, wherein the light source 22 is electrically linked to the rechargeable power unit 21 and is supported at the shoe body for generating light as a visible alert signal. According to the preferred embodiment, the rechargeable power unit 21 comprises a power unit 211 disposed in the insole cavity 111 of the shoe insole 11, and a charging terminal 212 extended from the power unit 211 for electrically connecting to an external power source to charge the power unit 211.

The light source 22 comprises one or more light generators 221 electrically linked to the rechargeable power unit 21 for light generation. Preferably, the light generator 221 is a LED for generating light with different light effects, such as different colors and different flashing patterns. In particular, the light source 22 is mounted at the shoe insole 11 in an invisible hidden manner, such that the light generated by the light source 22 cannot be seen.

In order to generate the visible alert signal, the alert module 20 further comprises a light transmitting element 23 operatively extended from the light source 22 to the shoe body 10 for transmitting the light from the light source 22 to form a continuous line of light at the shoe body 10 as the visible alert signal. Since the light source 22 is invisible hidden by the shoe insole 11, the light from the light source 22 will transmit to the light transmitting element 23 to ensure an even light intensity of the continuous line of light along the light transmitting element 23 at the shoe body 10. Preferably, the light transmitting element 23 is extended along an outer peripheral edge of the shoe insole 11 and/or along a seam line of the shoe cover 12. In other words, even though the shoe insole 11 is not made of transparent material, the shoe of the present invention can still provide a continuous line of light along the outer peripheral edge of the shoe insole 11 so as to prevent any visible bright spot at the shoe body 10. Accordingly, the continuous line of light generated by the light transmitting element 23 is a visible light which makes the wearer safe especially in a dark environment.

In particular, the light from the light source 22 will entirely project or refract along the light transmitting element 23 at its length, such that the light is repeatedly refracted along the light transmitting element 23 to form the continuous line of light.

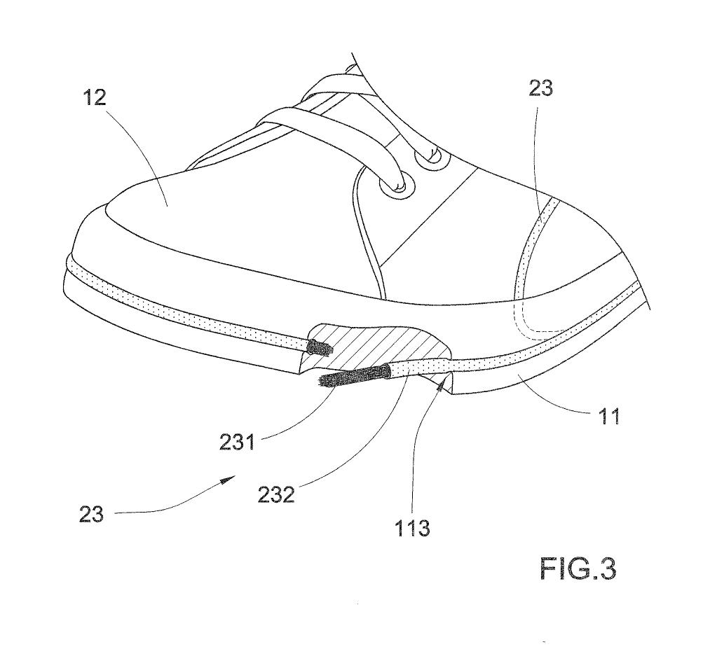

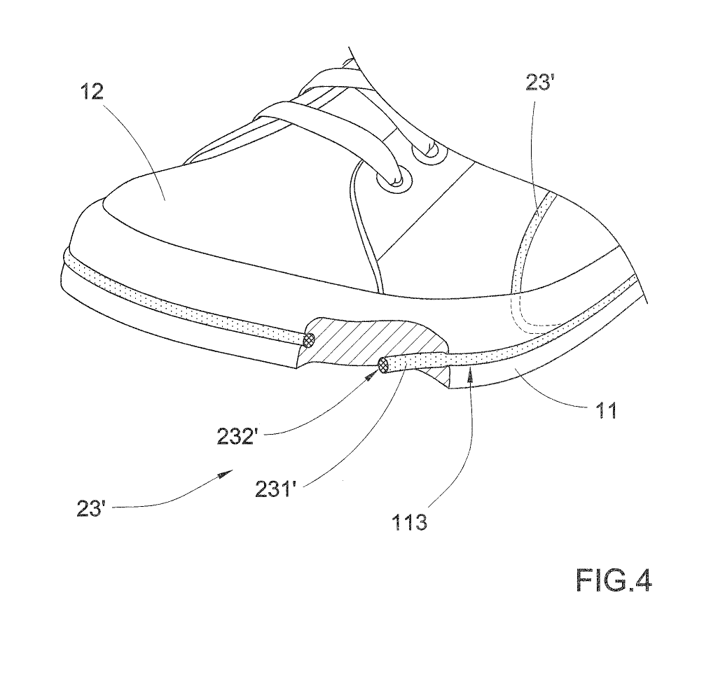

As shown in FIGS. 3 and 4, the shoe insole 11 has at least a communication through hole 112 formed at the shoe insole 11 to communicate an interior of the shoe insole 11, i.e. the insole cavity 111, with an exterior thereof, and an elongated receiving groove 113 extended from the communication through hole 112 and indented at the outer peripheral edge of the shoe insole 11 to receive the light transmitting element 23 along the receiving groove 113. Accordingly, the receiving groove 113 defines an elongated side opening along the outer peripheral edge of the shoe insole 11 to receive the light transmitting element 23. Preferably, the communication through hole 112 is formed at a rear portion of the shoe insole 11. It is worth mentioning that since the shoe insole 11 is made of elastic material to absorb the impact or pressure during walking or running, the receiving groove 113 is slightly deformed by the impact or pressure in order to securely retain the light transmitting element 23 along the receiving groove 113. Preferably, a size of the elongated side opening of the receiving groove 113 is slightly smaller than a width of the receiving groove 113, such that once the light transmitting element 23 is received along the receiving groove 113 through the elongated side opening thereof, the light transmitting element 23 will not be squeezed out of the receiving groove 113.

Accordingly, the light generator 221 is extended through the communication through hole 112 in order to operatively link the light generator 221 to the rechargeable power unit 11 within the interior of the shoe insole 11, wherein the light transmitting element 23 is operatively coupled with the light generator 221 to extend along the receiving groove 113, such that the light transmitting element 23 is extended along the outer peripheral edge of the shoe insole 11. Preferably, two light generators 221 are extended through two spaced apart communication through holes 112, wherein two ends of the light transmitting element 23 are extended between the two light generators 221 along the receiving groove 113. As a result, when the light generators 221 are activated for light generation, the light is transmitted along the light transmitting element 23 to form the continuous line of light in order to light up the outer peripheral edge of the shoe insole 11.

In order to hide the light generator 221, the shoe insole 11 further comprises a light blocking layer 114 affixed to the outer peripheral edge of the shoe insole 11 to cover the communication through hole 112, so as to prevent any visible bright spot of the light generator 221 at the shoe body 10. The light blocking layer 114 can be configured as a shoe label or decorative layer of the shoe to affix at the rear portion of the shoe insole 11 to cover the communication through hole 112.

It is worth mentioning that the light transmitting element 23 can further extend to the outer surface of the shoe body 12 to light up a desired portion thereof, as shown in FIG. 1. The light transmitting element 23 can further extend from the receiving groove 113 to the outer surface of the shoe body 12 along a seam line thereof. For example, the light transmitting element 23 can extend to the shoe logo at the shoe body 12 to light up the shoe logo, wherein the light blocking layer 114 can be affixed to the shoe body 12 to ensure a desired section of the shoe body 12 to be lighten up via the light transmitting element 23.

According to the preferred embodiment, the light transmitting element 23 comprises a plurality of optical fiber strands 231 twisted to form an elongated flexible light transducer extended from the light source 22, as shown in FIG. 3, such that the light from the light source 22 is transmitted to the optical fiber strands 231. Since the optical fiber strands 231 are twisted with each other, the optical fiber strands 231 will be lighten up to form the continuous line of light along the shoe body 10. In other words, the light is repeatedly refracted along the optical fiber strands 231 of the light transmitting element 23 to form the continuous line of light. In particular, the optical fiber strands 231 are extended along the receiving groove 113 to light up the outer peripheral edge of the shoe insole 11 and are extended to the outer surface of the shoe body 12 to light up the desired section thereof.

In order to protect the optical fiber strands 231, the light transmitting element 23 further comprises a flexible protective sleeve 232 which is made of light transmissible material and is extended along the receiving groove 113, wherein the optical fiber strands 231 are received along the flexible protective sleeve 232, such that the flexible protective sleeve 232 will protect the optical fiber strands 231 and retain the optical fiber strands 231 in a twisted manner. Therefore, the flexible protective sleeve 232 is received along the receiving groove 113 to retain the optical fiber strands 231 in position.

Alternatively, the light transmitting element 23′ comprises a flexible light tube 231′ to define a solid light transmitting channel 232′ extended from the light source 22, as shown in FIG. 4, such that the light from the light source 22 is transmitted to the flexible light tube 231′ through the solid light transmitting channel 232′ to form the continuous line of light along the shoe body 10. In other words, the light is repeatedly refracted along the solid light transmitting channel 232′ of the flexible light tube 231′ of the light transmitting element 23 to form the continuous line of light. In particular, the flexible light tube 231′ can be extended along the receiving groove 113 to light up the outer peripheral edge of the shoe insole 11 and are extended to the outer surface of the shoe body 12 to light up the desired section thereof.

According to the preferred embodiment, the control module 30 is supported in the shoe insole, wherein the control module 30 comprises an activation switch 31 operatively linked to the alert module 20 to selectively control the light source 22 in an on-and-off manner and to adjustably control different light effects of the light source 22.

Preferably, the activation switch 31 comprises a power switch 311 operatively linked to the light source 22 to selectively control the light source 22 in an on-and-off manner, wherein the power switch 311 can be a piezoelectric switch that the wearer is able to manually switch on-and-off the light source 22. Once the light source 22 is activated, the control module 30 will automatically switch the light source 22 from one light effect to another light effect by means of time interval or by means of numbers of steps. Likewise, when the power switch 311 is actuated once, the light source 22 is switched on. Then, when the power switch 311 is actuated again, the light source 22 is activated to adjustably switch different light effects thereof. For example, the power switch 311 is actuated four times to switch four different light effects of the light source 22. Once the power switch 311 is actuated at the fifth time, the light source 22 is switched off.

It is appreciated that the activation switch 31 further comprises a pressure switch 312 to selectively control the light source 22, such that when the wearer applies a pressure on the pressure switch 312, such as during walking or running, the light source 22 is automatically activated to adjustably switch different light effects thereof. Accordingly, both the power switch 311 and the pressure switch 312 can be incorporated with each other to selectively control the light source 22 in an on-and-off manner and to adjustably control different light effects of the light source 22.

According to the preferred embodiment, the control module 30 further comprises a health monitoring module 32 operatively linked to the activation switch 31 for counting numbers of the activation switch 31 to be activated as a pedometer. Accordingly, the health monitoring module 32 comprises an activation counting circuit 321 operatively linked to the activation switch 31 to count the number of activation of the activation switch 31. Preferably, the health monitoring module 32 is activated by the power switch 311 and is operatively linked to the pressure switch 312. When the pressure switch 312 is actuated by the pressure of the wearer's foot, the activation counting circuit 321 will count as one activation of the activation switch 31. When a predetermined number of activation of the activation switch 31 is over a preset step threshold preset in the activation counting circuit 321, the light source 22 is automatically switched from one light effect to another light effect as health signal to the wearer.

Researches have established baseline activity levels based on the number of steps taken each day. In particular, walking can be a part of a healthy weight loss program, wherein about 10,000 steps is equivalent of exercising for 30 minutes. The health monitoring module 32 of the present invention is able to help the wearer to count the number of steps. Once the health monitoring module 32 is activated, the health monitoring module 32 will start counting the number of steps of the wearer. For example, the health monitoring module 32 counts 5,000 steps of the wearer, i.e. the pressure switch 312 being pressured 5,000 times, the light source 22 is automatically switched from one light effect to another light effect. In other words, when the wearer sees the change of the light effect, he or she will notify that he or she already finished 5,000 steps in this time period. In other words, the wearer is able to set the target, such as 20,000 steps, such that when the light effect is changed three times, the wearer will notify the target has been completed.

According to the preferred embodiment, the control module 30 further comprises a control application 33 adapted for being installed and executed by an electronic device D, such as a portable electronic device or smart phone, wherein the control application 33 is wirelessly linked to the health monitoring module 32 for receiving health data therefrom and for sending control data to the control module 30.

Accordingly, the control application 33 is embodied as an “App” or software to be downloaded and installed into the electronic device D. Once the control application 33 is executed by the electronic device D, the wearer is able to input information into the electronic device D.

The personal information contains screen name, first and last name of the wearer, address information, gender, birthday, user email address, and/or password. The user biometric information contains height, weight, displayed unit of measure, and/or activity level. The exercise information contains exercise time, number of steps, distance, and/or calories. The data transmission information contains information of the health monitoring module 32 and the control application 33. The wireless connection between the health monitoring module 32 and the control application 33 can be in form of “Bluetooth”, “Radio frequency”, “Infra-red”, “WiFi”, “NFC” or any other wireless data transfer technology. It should be appreciated that the control application 33 can be connected to the health monitoring module 32 by cable.

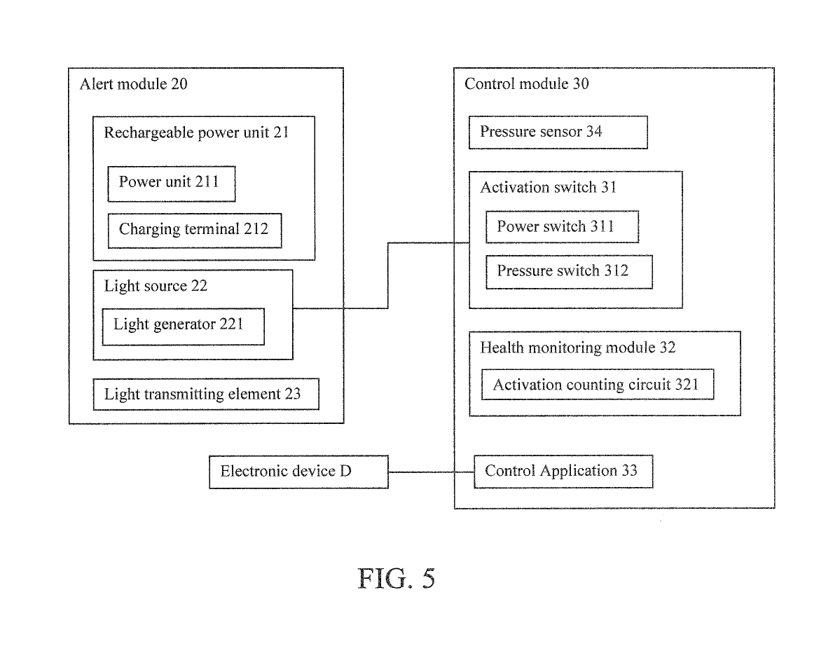

As shown in FIGS. 1 and 5, the control module 30 further comprises a pressure sensor 34 operatively linked to the activation switch 31 for detecting pressure being applied on the pressure sensor 34 when the activation switch 31 is actuated.

Accordingly, the pressure sensor 34 can be integrated with the pressure switch 312 to form an integrated pressure circuit to detect the pressure and to count the steps of the wearer at the same time.

Accordingly, the wearer is able to wirelessly control the alert module 20 via the control application 33 by sending control data to the control module 30. The wearer is able to wirelessly switch on/off the light source 22 and to selectively switch the light effects thereof by the control application 33. The wearer is able to set the step threshold in the activation counting circuit 321 via the control application 33.

Likewise, the wearer is able to monitor the health via the control application 33 by receiving health data from the health monitoring module 32. Accordingly, the number of steps of the wearer, as a health parameter, will wirelessly send to the control application 33, such that the control application 33 will calculate and determine the burnt calories according to the number of steps. The pressure data from the pressure sensor 34 will also send to the control application 33, such that the wearer is able to view the pressure on the shoe during walking or running. In particular, the wearer is able to view the pressures at the left foot and right foot of the wearer. The control application 33 will determine the proper pressure at the foot of the wearer in response to the weight of the wearer. For example, when the right foot pressure is larger than the left foot pressure, the control application 33 will generate an aware signal via the electronic device. At the same time, the light source 22 of the right shoe and the light source 22 of the left shoe will generate different light effects as well. In other words, when the right foot pressure is approximately the same as the left foot pressure, the light source 22 of the right shoe and the light source 22 of the left shoe will generate the same light effect.

Accordingly, the control application 33 farther comprises a plurality of different fitness programs to be selected via the electronic device. In response to different fitness levels of the user, the user is able to select one of the fitness programs in the control application 33. Once the fitness program is selected, such as 1,000 steps in three minutes, the alert module 20 will be activated to generate the desired light effect in response to the fitness program. For example, when the wearer completes 1,000 steps in three minutes, the light source 22 will switch one light effect to another light effect to notify the wear the completion of the fitness program.

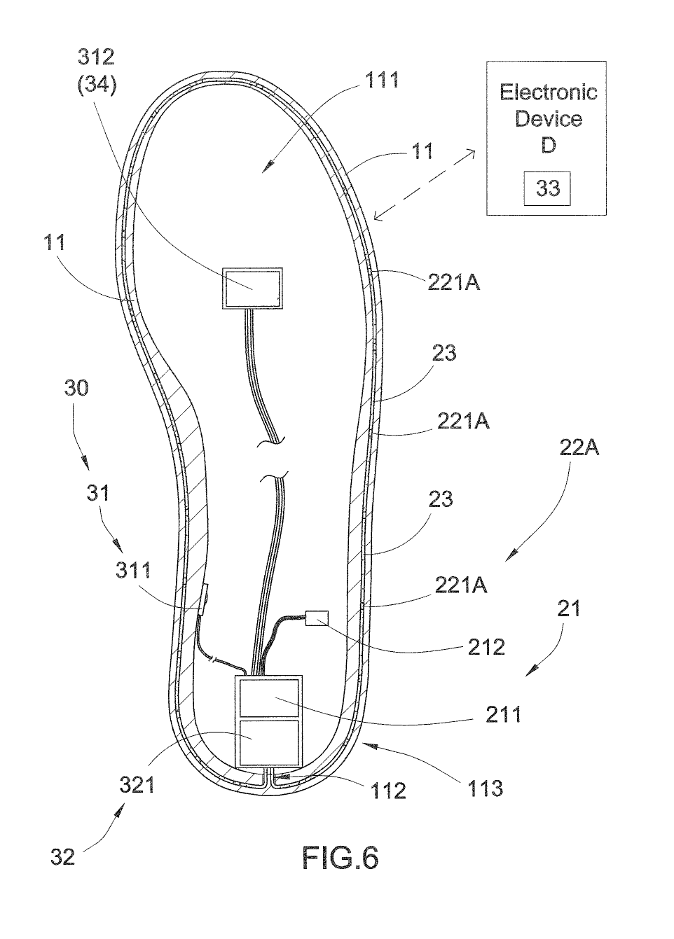

FIG. 6 illustrates an alternative mode of the light source 22A, wherein the light source 22A comprises a plurality of light generators 221A spacedly coupled at the outer peripheral edge of the shoe insole 11 and being selectively activated by the control module 30. Accordingly, the light generators 221A are a plurality of LEDs embedded within the shoe insole 11, wherein the shoe insole 11 is preferably made of light transmitting material to allow the lights from the light generators 221 A penetrating therethrough. Preferably, the light generators 221A are located at the front portion, two side portions, and the rear portion of the shoe insole 11. In particular, the control module 30 is able to selectively control which light generator 221A to be activated, such as by the control application 33. In addition, the light transmitting element 23 is operatively extended between every two of the light generators 221A.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A shoe, comprising:
a shoe body which comprises a shoe insole and a shoe cover affixed on said shoe insole; and
an alert module which comprises a light source supported at said shoe body for light generation, and a light transmitting element operatively extended from said light source to said shoe body for transmitting the light from said light source to form a continuous line of light at said shoe body as a visible alert signal.

2. The shoe, as recited in claim 1, wherein said light source is mounted at said shoe insole in an invisible hidden manner that said light from said light source is transmitted to said light transmitting element, so as to ensure an even light intensity of said continuous line of light at said shoe body.

3. The shoe, as recited in claim 1, wherein said light transmitting element comprises a plurality of optical fiber strands twisted to form an elongated flexible light transducer extended from said light source and along said shoe body.

4. The shoe, as recited in claim 2, wherein said light transmitting element comprises a plurality of optical fiber strands twisted to form an elongated flexible light transducer extended from said light source and along said shoe body.

5. The shoe, as recited in claim 1, wherein said light transmitting element comprises a flexible light tube to define a solid light transmitting channel extended from said light source and along said shoe body.

6. The shoe, as recited in claim 2, wherein said light transmitting element comprises a flexible light tube to define a solid light transmitting channel extended from said light source and along said shoe body.

7. The shoe, as recited in claim 1, wherein said light transmitting element is extended along an outer peripheral edge of said shoe insole,

8. The shoe, as recited in claim 4, wherein said light transmitting element is extended along an outer peripheral edge of said shoe insole.

9. The shoe, as recited in claim 6, wherein said light transmitting element is extended along an outer peripheral edge of said shoe insole.

10. The shoe, as recited in claim 8, wherein said shoe insole has at least a communication through hole formed at said shoe insole to communicate an interior of said shoe insole with an exterior thereof, and an elongated receiving groove extended from said communication through hole and indented at said outer peripheral edge of said shoe insole to receive said light transmitting element along said receiving groove.

11. The shoe, as recited in claim 10, wherein said light transmitting element further comprises a flexible protective sleeve, which is made of light transmissible material, extended along said receiving groove to receive said optical fiber strands in a twisted manner.

12. The shoe, as recited in claim 9, wherein said shoe insole has at least a communication through hole formed at said shoe insole to communicate an interior of said shoe insole with an exterior thereof, and an elongated receiving groove extended from said communication through hole and indented at said outer peripheral edge of said shoe insole to receive said light transmitting element along said receiving groove.

13. The shoe, as recited in claim 1, further comprising a control module supported in said shoe insole, wherein said control module comprises an activation switch operatively linked to said alert module to selectively control said light source in an on-and-off manner and to adjustably control different light effects of said light source.

14. The shoe, as recited in claim 2, further comprising a control module supported in said shoe insole, wherein said control module comprises an activation switch operatively linked to said alert module to selectively control said light source in an on-and-off manner and to adjustably control different light effects of said light source.

15. The shoe, as recited in claim 13, wherein said control module further comprises a health monitoring module operatively linked to said activation switch for counting numbers of said activation switch to be activated as a pedometer, such that when a predetermined number of activation of said activation switch is over a preset step threshold, said light source is automatically switched from one light effect to another light effect.

16. The shoe, as recited in claim 14, wherein said control module further comprises a health monitoring module operatively linked to said activation switch for counting numbers of said activation switch to be activated as a pedometer, such that when a predetermined number of activation of said activation switch is over a preset step threshold, said light source is automatically switched from one light effect to another light effect.

17. The shoe, as recited in claim 15, wherein said control module further comprises a control application adapted for being installed and executed by an electronic device, wherein said control application is wirelessly linked to said health monitoring module for receiving health data therefrom and for sending control data to said control module.

18. The shoe, as recited in claim 16, wherein said control module further comprises a control application adapted for being installed and executed by an electronic device, wherein said control application is wirelessly linked to said health monitoring module for receiving health data therefrom and for sending control data to said control module.

19. The shoe, as recited in claim 15, wherein said control module further comprises a pressure sensor operatively linked to said activation switch for detecting pressure being applied on said pressure sensor when said activation switch is actuated.

20. The shoe, as recited in claim 18, wherein said control module further comprises a pressure sensor operatively linked to said activation switch for detecting pressure being applied on said pressure sensor when said activation switch is actuated.

21. A shoe, comprising:
a shoe body which comprises a shoe insole and a shoe cover affixed on said shoe insole;
an alert module which comprises a rechargeable power unit, and a light source which is electrically linked to said rechargeable power unit and is supported at said shoe body for generating light with different light effects as a visible alert signal; and
a control module which comprises an activation switch operatively linked to said alert module to activate said light source, and a health monitoring module operatively linked to said activation switch to automatically switch said light source from one light effect to another light effect when a predetermined number of activation of said activation switch is over a preset step threshold.

22. The shoe, as recited in claim 21, wherein said control module further comprises a control application adapted for being installed and executed by an electronic device, wherein said control application is wirelessly linked to said health monitoring module for receiving health data therefrom and for sending control data to said control module.

23. The shoe, as recited in claim 21, wherein said control module further comprises a pressure sensor operatively linked to said activation switch for detecting pressure being applied on said pressure sensor when said activation switch is actuated.

24. The shoe, as recited in claim 22, wherein said control module further comprises a pressure sensor operatively linked to said activation switch for detecting pressure being applied on said pressure sensor when said activation switch is actuated.

25. The shoe, as recited in claim 21, wherein said light source comprises a plurality of light generators spacedly coupled at an outer peripheral edge of said shoe insole and being selectively activated by said control module.

26. The shoe, as recited in claim 24, wherein said light source comprises a plurality of light generators spacedly coupled at an outer peripheral edge of said shoe insole and being selectively activated by said control module.

27. The shoe, as recited in claim 21, wherein said alert module further comprises a light transmitting element operatively extended from said light source to said shoe body for transmitting the light from said light source so as to form a continuous line of light at said shoe body.

28. The shoe, as recited in claim 26, wherein said alert module further comprises a light transmitting element operatively extended from said light source to said shoe body for transmitting the light from said light source so as to form a continuous line of light at said shoe body.

29. The shoe, as recited in claim 28, wherein said light transmitting element operatively extended between every two of said light generators.

30. The shoe, as recited in claim 27, wherein said light transmitting element comprises a plurality of optical fiber stands twisted to form an elongated flexible light transducer extended from said light source and along said shoe body.

31. The shoe, as recited in claim 27, wherein said light transmitting element comprises a flexible light tube to define a solid light transmitting channel extended from said light source and along said shoe body.
